(19) United States
(12) Patent Application Publication
(10) Pub. No.: US 2002/0069293 A1
(43) Pub. Date: Jun. 6, 2002

(54) Method to distribute information in an airport

(76) Inventor: Emer B. Natalio, Plantation, FL (US)

Correspondence Address: SAWYER LAW GROUP LLP, P O BOX 51418, PALO ALTO, CA, 94303, US

(21) Appl. No.: 09/905,118

(22) Filed: Jul. 13, 2001

Related U.S. Application Data
(60) Provisional application No. 60/218,428, filed on Jul. 14, 2000.

(51) Int. Cl. G06F 15/173; G06F 15/16

(52) U.S. Cl. 709/238; 709/202

(57) ABSTRACT

An airport information distribution system is disclosed. The airport information distribution system comprises at least one airport data center. The airport data center includes an airport information database and a server coupled to the airport information database. The system includes a network coupled to the data center and an information distribution system coupled to the network. The information distribution system includes a server system coupled to the network for receiving information from the at least one airport data center and for providing and receiving data from a communication device concerning airport information. In addition, a method for distributing airport information is disclosed. The method includes providing an airport information database within an airport data center and initiating a request for information from the airport information database by a wireless communication device. The method further includes obtaining information related to the request by the wireless communication device.

### FIELD OF THE INVENTION

The present invention relates generally to a method for distributing information in an airport in multiple languages.

### BACKGROUND OF THE INVENTION

Keeping passengers informed is extremely important in modern airports where surroundings are unfamiliar and time is critical. Airport passengers rely upon information to guide them to their desired destination. They may need to find the proper gate for boarding or where to go to pick up their baggage. Passengers also need to know which kinds of services are available in an airport, such as restaurants or shuttle services, and where to locate these services. In the modern airport, passengers also speak a variety of languages, and they may not speak English or the prevalent language spoken in the community where the airport is located.

At the present time passengers must rely on whatever signs or display screens they can find to obtain the information they need. Often such signs or display screens are difficult to locate, especially when a passenger is in a time-critical situation, and conventional airport signage is usually displayed in one or, at best, two languages.

What is needed is a method and system for quickly and easily providing information to passengers in an airport in multiple languages, offering passengers the additional convenience of accessing such information via electronic means such as personal data assistants (PDAs) or other portable computer devices. The present invention addresses such a need.

### SUMMARY OF THE INVENTION

An airport information distribution system is disclosed. The airport information distribution system comprises at least one airport data center. The airport data center includes an airport information database and a server coupled to the airport information database. The system includes a network coupled to the data center and an information distribution system coupled to the network. The information distribution system includes a server system coupled to the network for receiving information from at least one airport data center and for providing and receiving data from a communication device concerning airport information. In addition, a method for distributing airport information is disclosed. The method includes providing an airport information database within an airport data center and initiating a request for information from the airport information database by a wireless communication device. The method further includes obtaining information related to the request by the wireless communication device.

### BRIEF DESCRIPTION OF THE DRAWINGS

FIG. 1 illustrates the needed hardware, software and connections for the present invention AirportX to interface with domestic airports.

FIG. 2 indicates the kinds of local resource information on a display screen specific to each particular airport that will be provided to a traveler via wireless devices.

FIGS. 3 thru 11 are flowcharts of the screen shots and filenames illustrating the screens and filenames being used to deliver the information in multiple languages in accordance with the present invention.

### DETAILED DESCRIPTION

The present invention relates generally to a method for distributing information in an airport in multiple languages. The following description is presented to enable one of ordinary skill in the art to make and use the present invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A method and system in accordance with the present invention (i.e., an airport information system, hereinafter referred to as the “AirportX” system”) provides travelers who are equipped with Internet-enabled mobile phones and personal digital assistants (PDAs) such as a Palm Pilot or other wireless device the ability to retrieve local resource information that is available to the traveler at an airport, as well as non-local information such as e-mail, events and attractions. The information accessed by the wireless device is provided in the language (Spanish, French, German and others) of choice for the users of the method and system in accordance with the present invention.

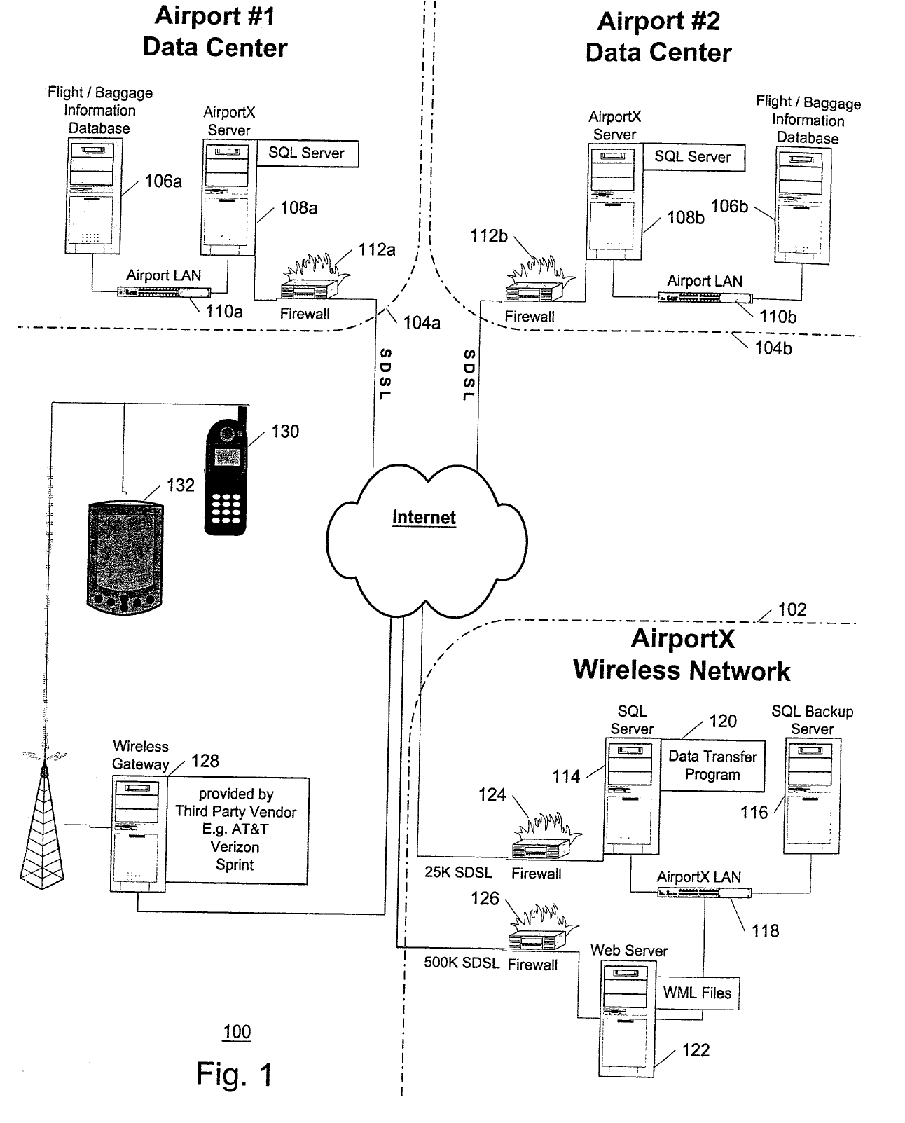

FIG. 1 illustrates the needed hardware, software and connections for the AirportX system 100 to interface with domestic airports. The system 100 comprises an AirportX wireless network 102, which couples (via a network 103, for example, the Internet) to a plurality of data centers 104a-104b at airports. As is well known, at airports there are flight information databases (FIDs) and baggage information databases (BIDs) which are represented as 106a and 106b respectively in the data centers 104a and 104b. Each of the data centers 104a and 104b also includes a server 108a and 108b that is coupled to the databases 106a and 106b by respective local area networks (LANs) 110a and 100b. Each of the airport data centers 104a-104b will host an SQL server 106a-106b that will, in a preferred embodiment, be maintained by a technical department related to the wireless network 102. In a preferred embodiment, a firewall 112a and 112b is utilized to prevent unauthorized data being received from or entering the respective data centers 104a and 104b.

The AirportX wireless network 102 comprises a first server 114 and a back-up server 116, which is coupled thereto by a LAN 118. The server 114 includes a data transfer program 120. The network 102 further includes a web server 122, which is coupled to the LAN 118. A first firewall 124 is coupled between the server 114 and the network 102. A second firewall 126 is coupled to the web server 122. The firewall 126 is, in turn, coupled to a wireless gateway 128. The wireless gateway, which is preferably provided by a third-party vendor such as ATA&T, Verizon or Sprint, allows for a wireless device (i.e., telephone 130, POA 132 or some other device) to communicate with the AirportX wireless network 102.

Services will be accessed via an Internet connection and/or an 800 number with information to be displayed via the mobile phones or the digital assistant's display screen. Much more time is required to access, listen to and choose information selections than to view information choices via a display. Therefore, for non-enabled Internet mobile phones, information will be provided via interactive voice response using current technology of VoiceXML.

A scheduler in a preferred embodiment, developed in WS Script (Windows Scripting File), will automatically update the database in server 114 every 60 seconds. The database of the method and system in accordance with the present invention will extract only relevant information from the airport's BIDS/FIDS, i.e., flight time, gate, terminal and concourse data will be transferred to the present invention's database.

This data stored on server 114 will then be uploaded to web server 122 via a local area network (LAN) connection. Once the data is placed on the server 114 located at AirportX system's headquarters this data is accessed by the web server 122. Connecting points will be protected by firewall technologies as a deterrent to an intrusion from the outside world. All connections to the Internet will be through an ADSL or SDSL connection with high-speed requirements for dependable information update.

Once the data is stored in server 114 at its headquarters, the data is formatted using a combination of SQL stored procedures, XML (Extensible Markup Language) and XSL (Extensible Style sheet Language) and ASP (Active Server Pages).

In a preferred embodiment, the web server 122 is connected to the Internet so that any Internet-enabled wireless devices will be able to access AirportX's airport information by connecting to the Internet.

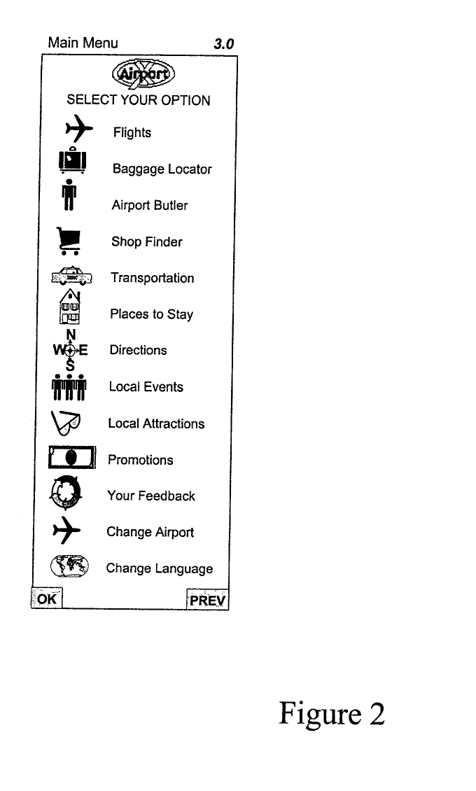

FIG. 2 indicates the kinds of local resource information on a display screen specific to each particular airport, which will be provided to a traveler. Local resource information includes data on flights, baggage locator, airport butler, shop finder, transportation systems, lodging, directions, local events, local attractions, promotions, feedback, and choice of airport and language.

The confluence of technologies utilized to create the AirportX platform for delivery of this present invention are:

Active Server Pages (ASP) is utilized to communicate with the Structured Query Language (SQL) database and a web server.

Extensible Markup Language (XML) is utilized to create a quick loading parsed data from the SQL database.

Extensible Stylesheet Language (XSL) is utilized to format the output of the data to its respective devices such as (Internet enabled phones and/or Personal Digital Assistants)

SQL stored procedures are used within the present invention's database structure to be able to execute variables for each screen layout depicted in FIG. 2.

Windows Scripting Language (WS Script) is also utilized in the present invention.

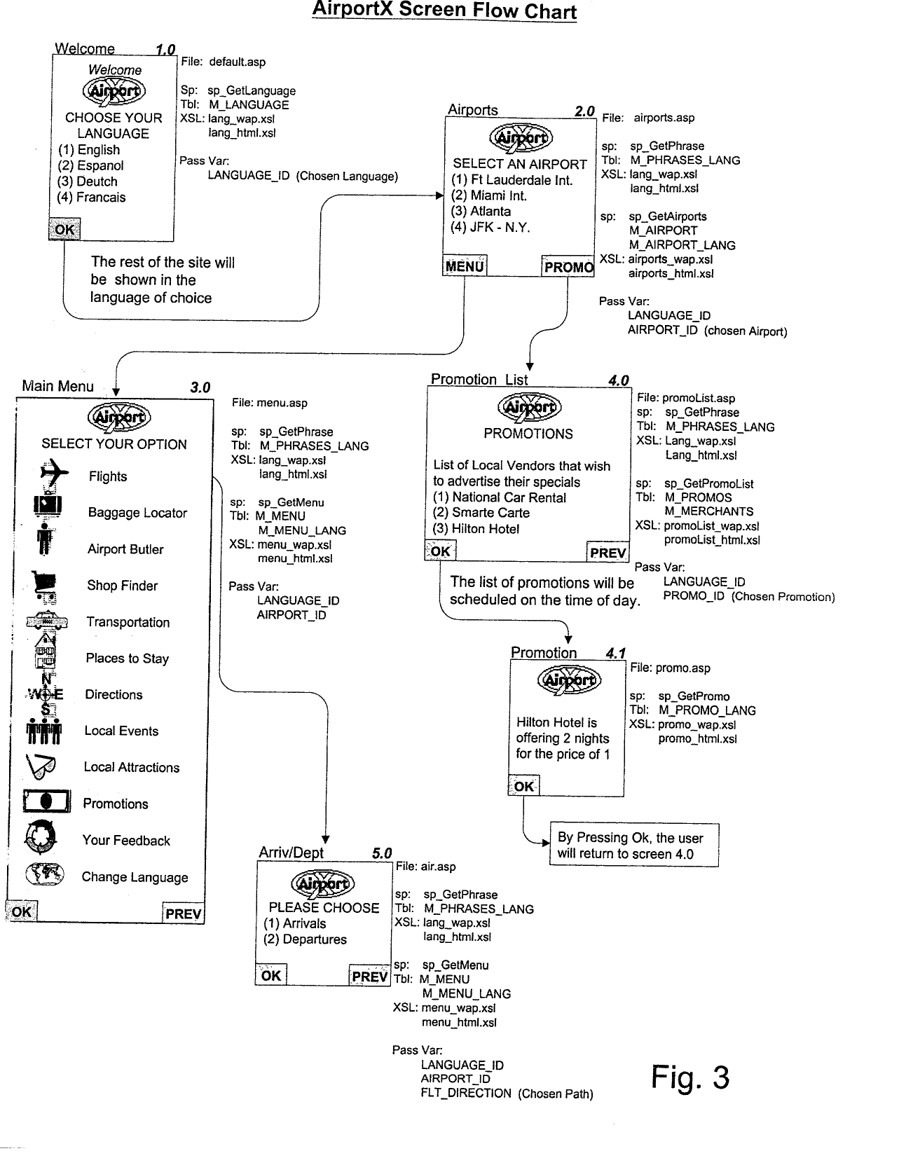

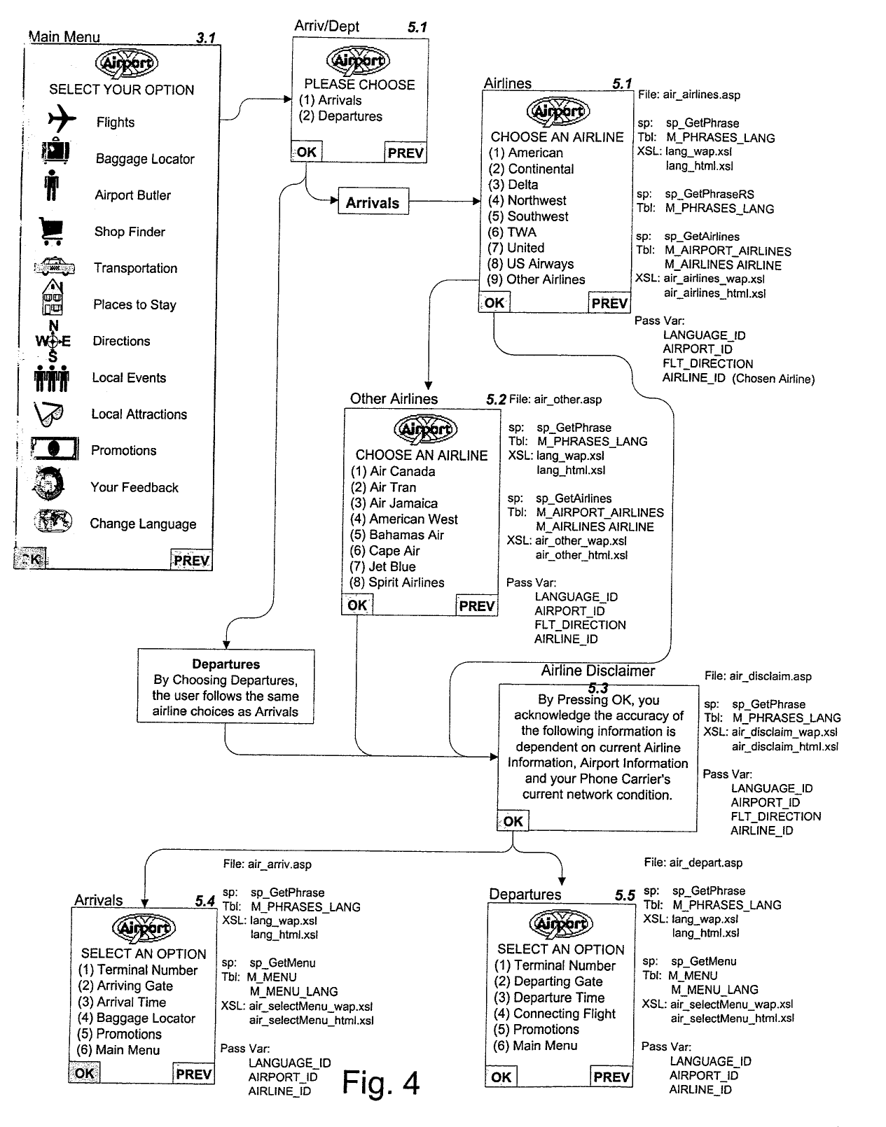

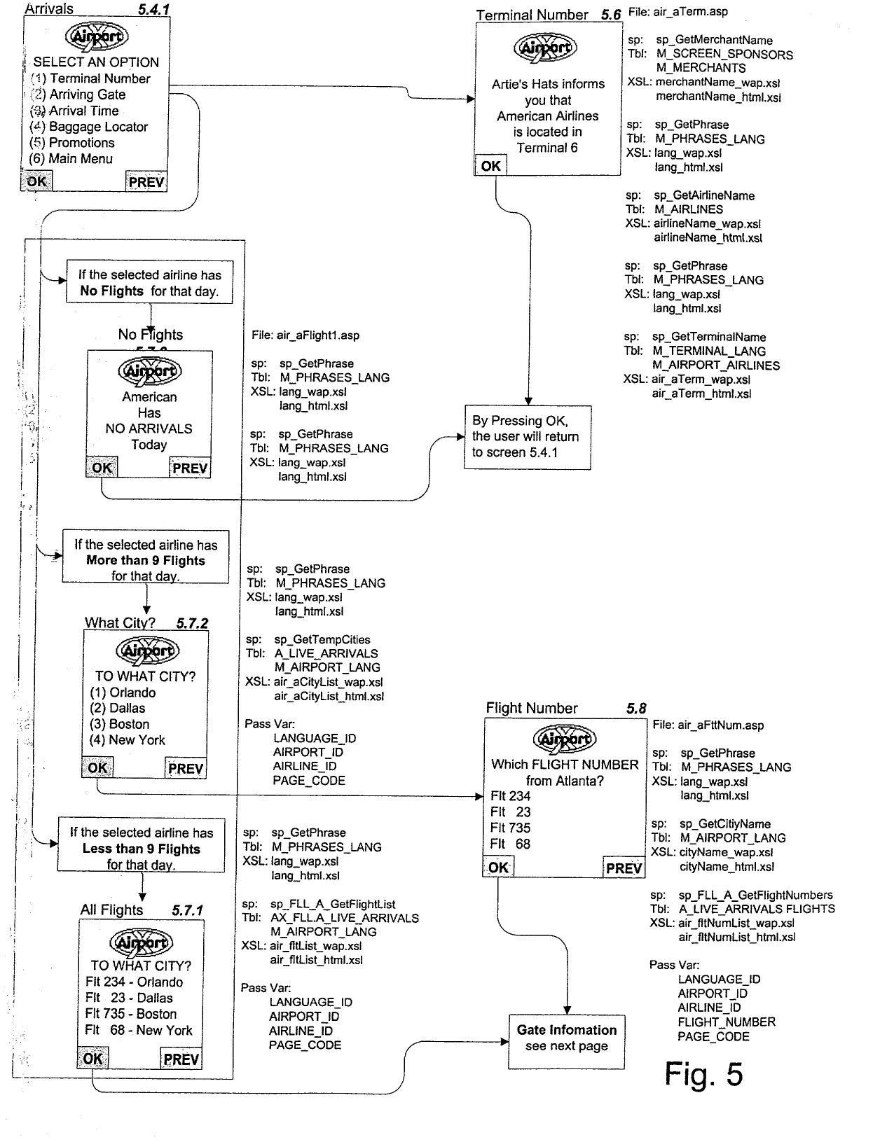

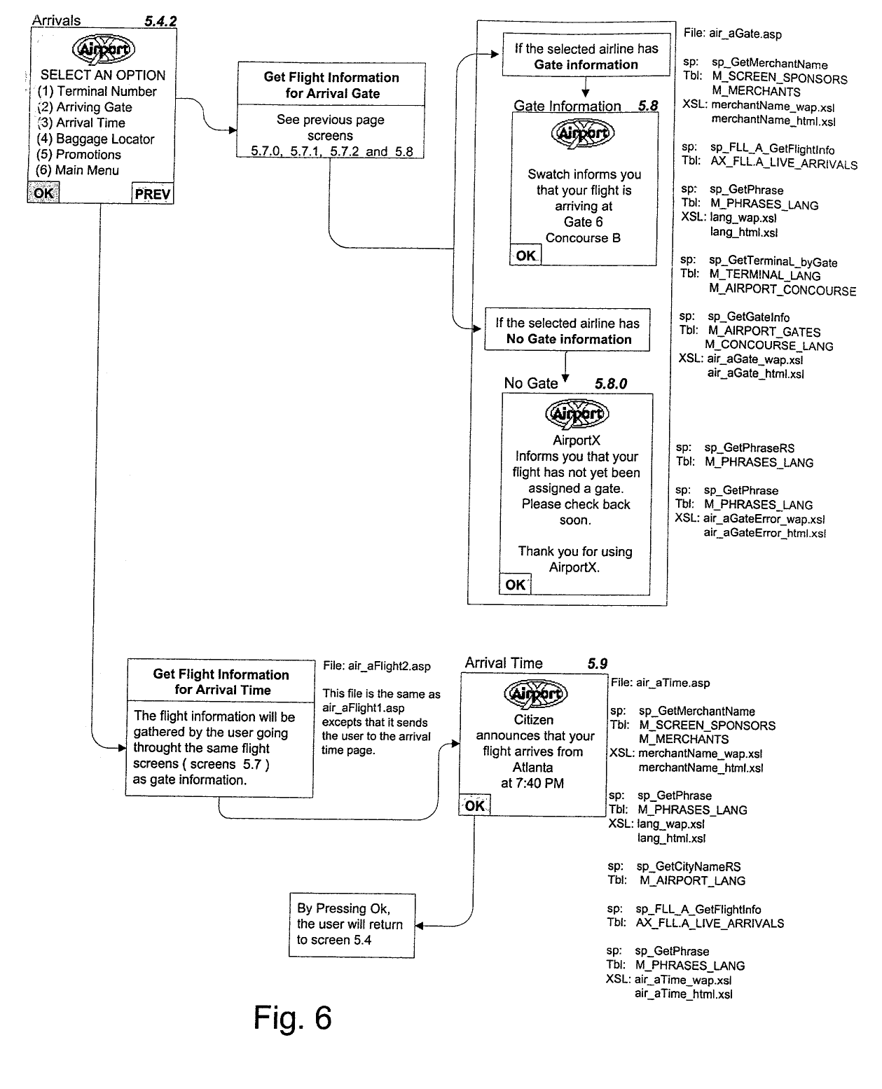

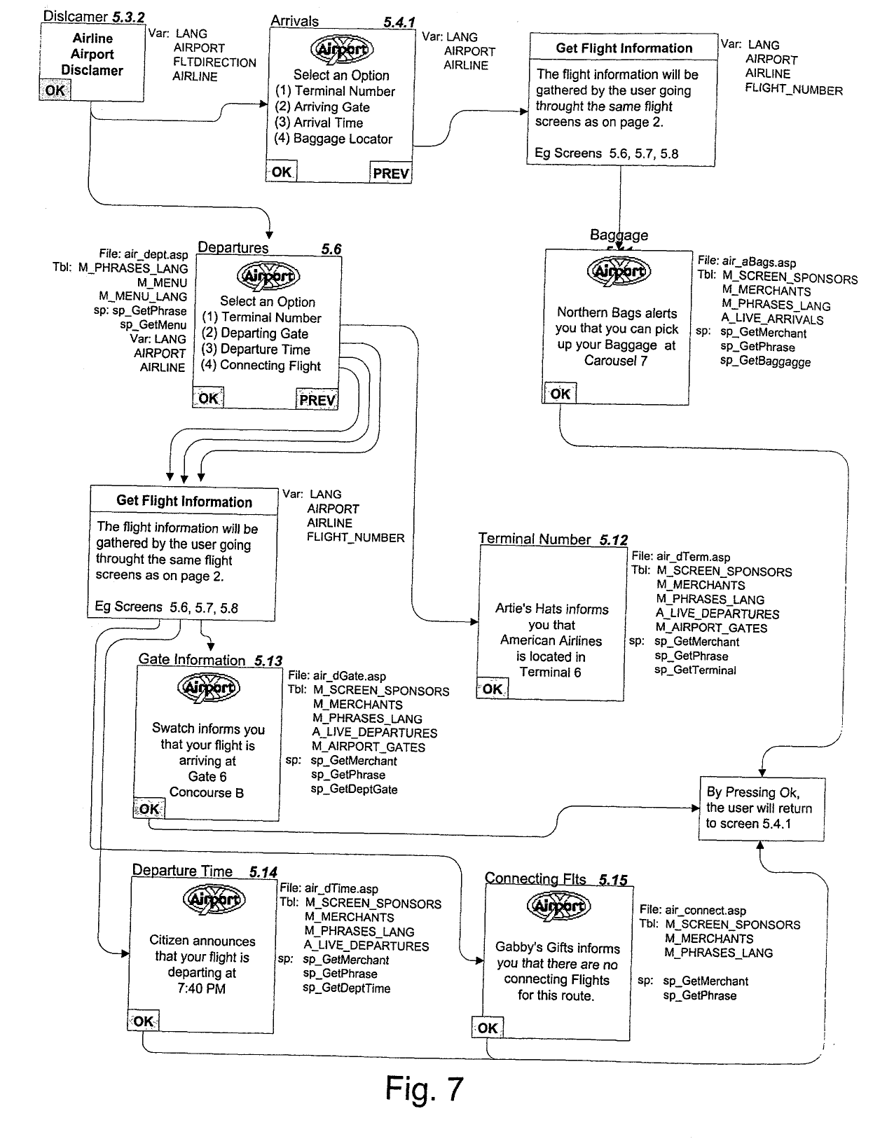

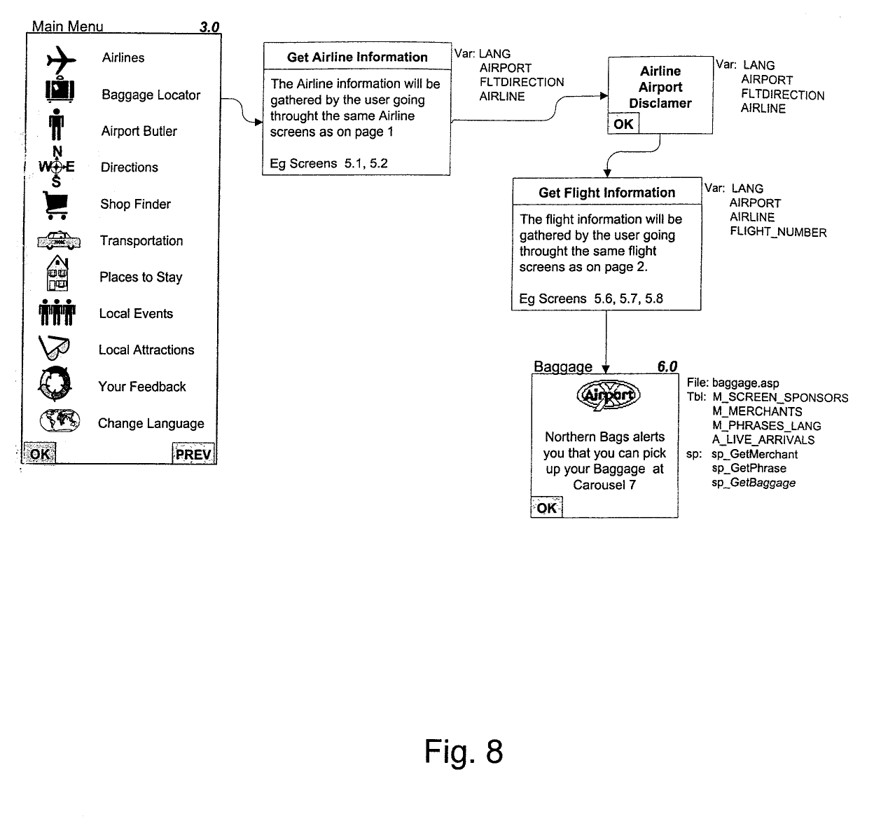

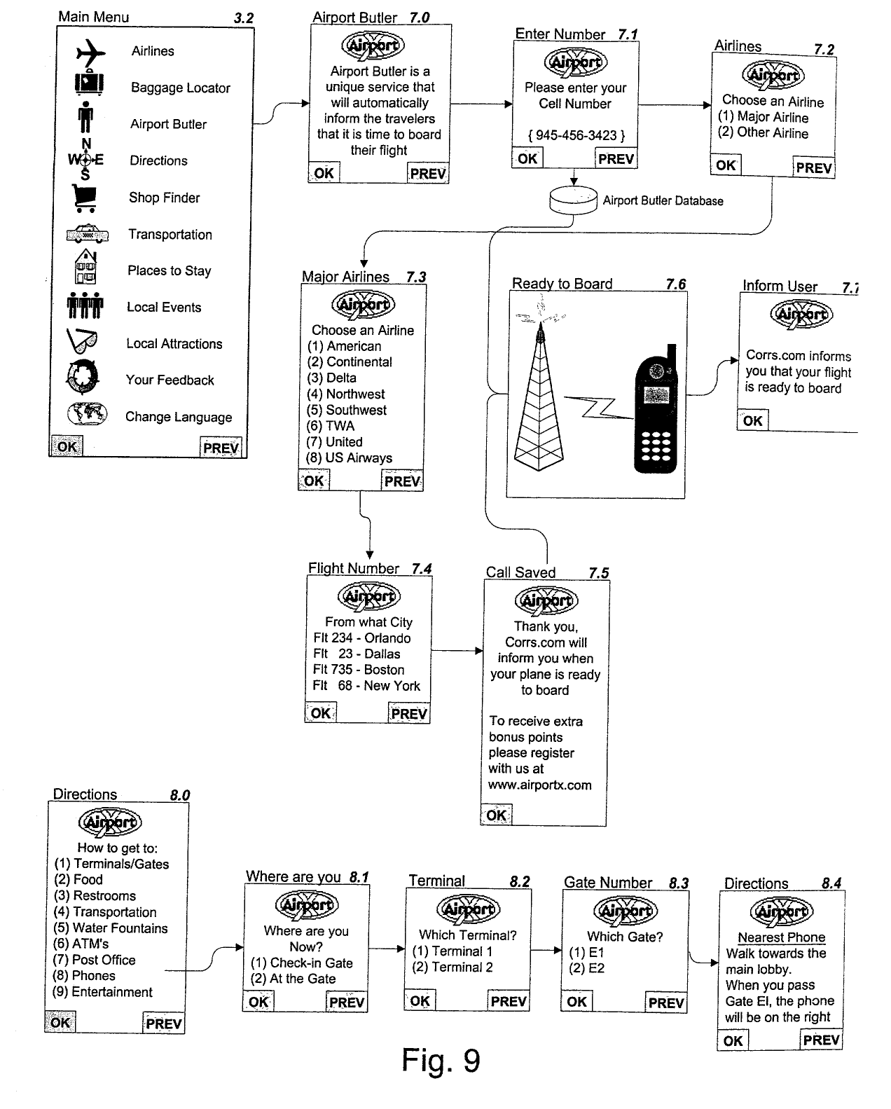

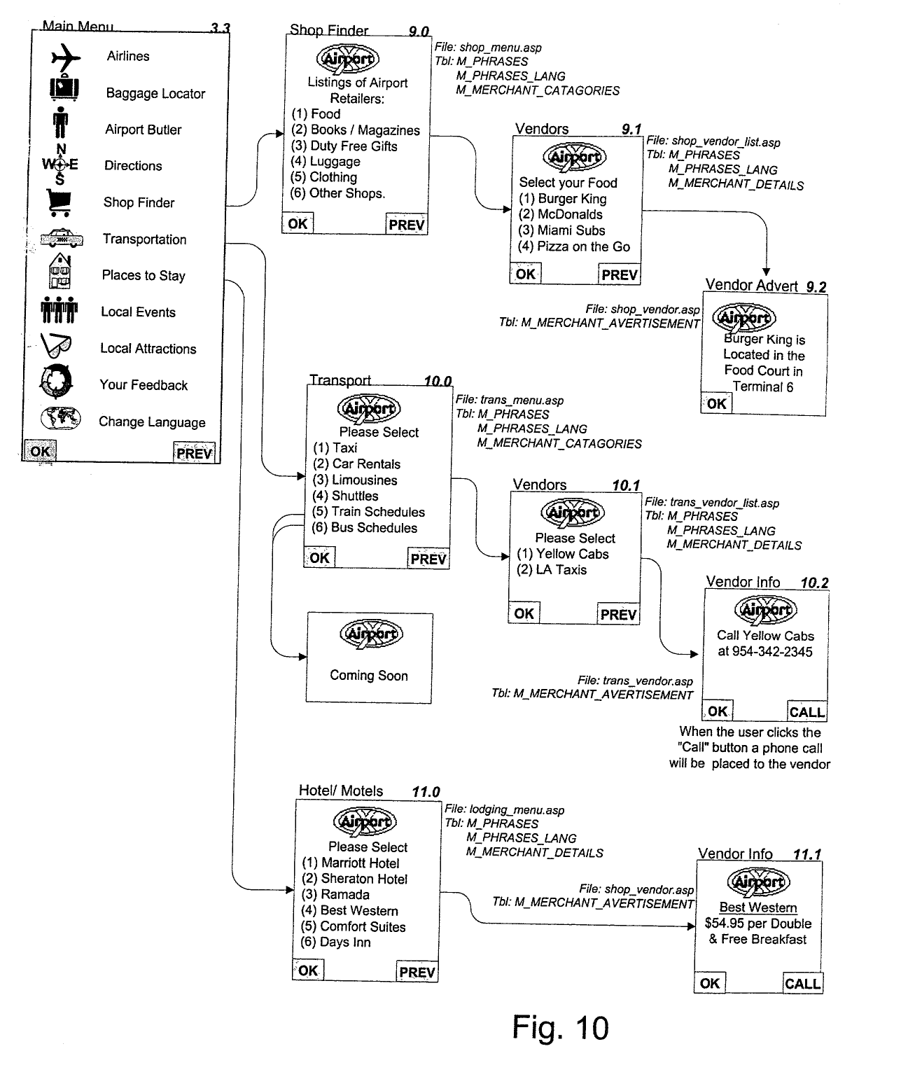

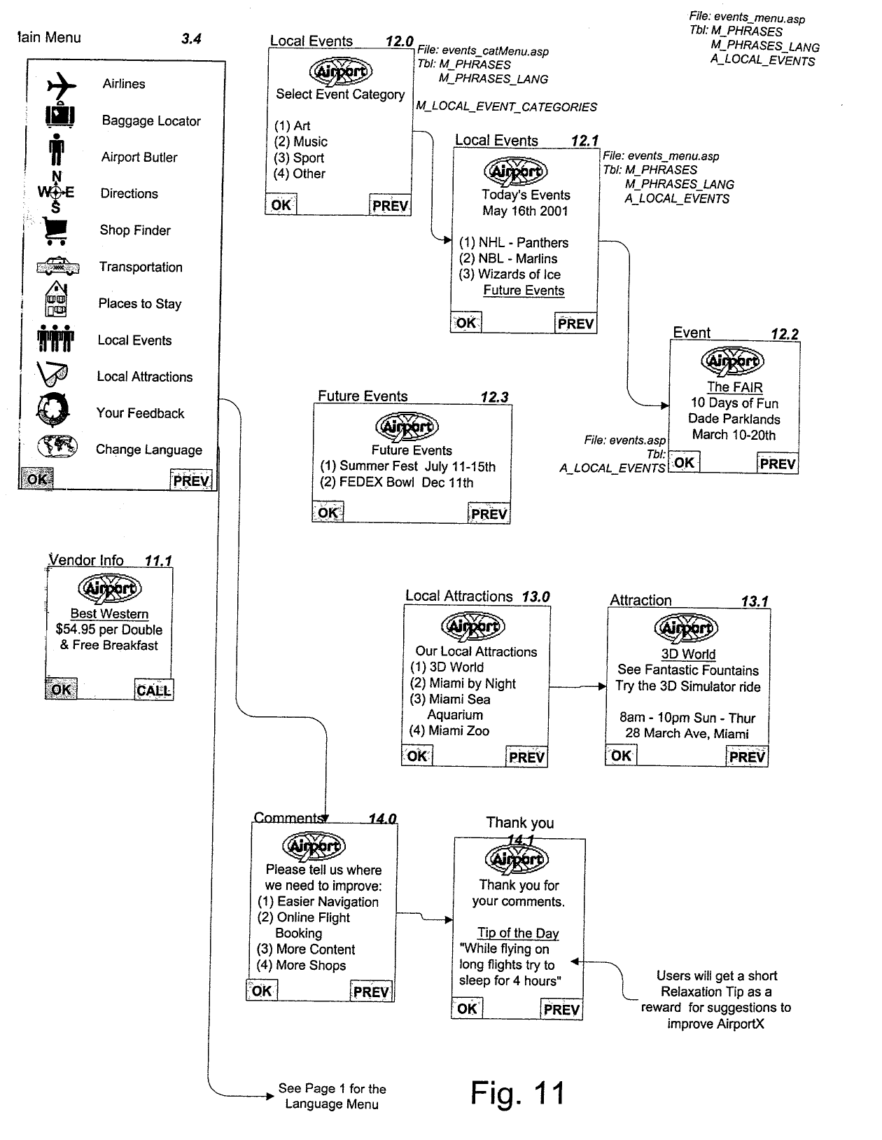

Referring now to FIG. 3, Screen 1.0 (“Welcome Screen”) is the first screen seen by the user of the service/system delivery with choices for multiple language availability which can at any time be expanded to other include additional languages availability. All following screens will be displayed in the language chosen by the user on screen 1.0.

Once the user has chosen a language in Screen 1.0, Screen 2.0 (“Airport Choice”) is displayed. Screen 2.0 allows the traveler to select the current airport for which the traveler needs information. Screen 2.0 is the first screen where promotional items (shown in Screen 4.0 and Screen 4.1) may be displayed. If the user chooses a promotional screen, they will then be taken visually to a promotional screen such as Screens 4.0 and 4.1.

Once the user has selected a particular airport via Screen 2.0, then Screen 3.0 is displayed. Screen 3.0, the “Main Menu”, describes current information selections which may be made by the user at this point. These include, but are not limited to, flight information, baggage locator, airport butler, shop finder, transportation, places to stay, directions, local events, local attractions, promotions, feedback and change of language choice.

The choices as displayed in Screen 3.0 could be displayed in another order, and additional choices could be offered at any time. The order of appearance on wireless devices could also vary from this illustration.

If the user chooses flight information from the Main Menu on Screen 3.0, then Screen 5.0 (“Arrival/Department”) appears. On Screen 5.0, the user may choose between arriving and departing flights.

Referring now to FIG. 4, Screen 5.2 asks the user to choose an airline. Both major and non-major airline listings are included.

Screen 5.2, which lists “other airlines”, fulfills the function of assisting airports by acting as an extension of monitors within each airport. Due to the addition of airlines to the major airlines (e.g. American Airlines, Delta, United, etc.) there is not enough real-estate space on locally positioned monitors inside airports today to include all airlines. The method and system in accordance with the present invention solves this problem by providing information regarding other airlines.

Screen 5.3 displays disclaimers related to the method and system of the present invention which the user must read before continuing. Users must press OK before proceeding to the next screen.

After arrivals or departures have been chosen by the traveler in Screen 5.1, and the user has agreed to the disclaimer presented in Screen 5.3, the user is then presented with Screen 5.4 (“Arrivals”) and Screen 5.5 (“Departures”). Choices offered are terminal number, arriving/departure gate, arrival/departure time, baggage locator option in the arrival option screen and connecting flight in the departures screen. These choices could be changed or added to at any time. Promotions and the option to return to the main menu are included on screens 5.4 and 5.5.

Referring now to FIG. 5, Screen 5.6 shows a hypothetical advertiser that will be displayed when a user selects the terminal number option from Screens 5.4 or 5.5.

If a selected airline has No Flights for the day Screen 5.7.0 will be shown, which states that no flights are scheduled for the particular airline for the time period requested. If the selected airline has more than nine flights for day or requested time period, Screen 5.7.2 will be displayed, asking what city the flight is originating from.

If the chosen airline has less than nine flights for the day or selected time period, Screen 5.7.1 will be shown displaying both flight number and city of origination.

This method of display is designed to reduce the amount of keypad strokes and stylus strokes on Internet enabled phones and on a personal digital assistant.

Screen 5.8 displays the continuation for the flight number choice selected in Screen 5.7.2.

Referring now to FIG. 6, when a user selects the Arriving Gate option from either the arrivals or departures screens 5.4 or 5.5 (FIG. 4) and when the selected airline can provide current gate information, then Screen 5.8 will be displayed with an accompanying hypothetical advertising mix.

If the selected airline has no gate information available, then Screen 5.8.0 will inform the wireless device owner that no current gate information is available at this time.

Screen 5.9 displays the arrival time in addition to a mix of advertising and arrival time information.

Referring now to FIG. 7, Screen 5.11 displays the baggage information. The information will be displayed with a mixture advertising and baggage location information.

In a preferred embodiment, the next several screens describe the process of a departure inquiry by the present invention. Screen 5.6 (Departures), and its sub-options of Terminal Number Screen 5.12, Gate Information at Screen 5.13.0, illustrate the gate information screen information display. Screen 5.14 displays departure time information with an accompanying advertisement. Screen 5.15 displays connecting flight information with accompanying advertising.

Referring now to FIG. 8, Screen 6.0 shows the baggage locator feature of the method and system in accordance with the present invention.

Referring to FIG. 9, Screen 7.0 illustrates “Airport Butler” as the third option from the Main Menu. “Airport Butler” is a service that will automatically inform travelers of delays and cancellations. “Airport Butler” will also notify the airport traveler that it is time to board their flight. Screen 7.1, is the screen where the user of the method and system in accordance with the present invention will enter their phone number so that they may be notified when their flight is ready to be boarded. Screens 7.2 and 7.3 offer choices of airlines (major or other). Screens 7.4 and 7.5 display flight selection and registration messages, respectively. Screen 7.7 is the final message by means of which “Airport Butler” informs the traveler of the boarding notification.

“Airport Butler” (notification/alert service) will provide information to the airport passenger as to whether flights are cancelled and delayed. In addition, as part of this service, passengers can be notified of when planes are boarding. The requirement for this notification service is registration via a web site by standard (wired) Internet connection or by wireless devices (Internet enabled mobile phones and personal digital assistants). In order to complete registration, participants will provide the person's first and last name and their respective mobile phone number. The current technology system that will be used to implement “Airport Butler” is via short message systems (SMS). SMS are utilized as part of wireless carriers' feature which 80% of the mobile phones today support.

Screen 8.0 offers information on finding the directions to locations such as terminals/gates, food, restrooms, transportation, water fountains, ATMs, post office, telephones and entertainment. Once the user has selected the kind of information desired in Screen 8.0, Screens 8.1, 8.2, 8.3 and 8.4 further define the directions information to help the user find what they are looking for.

Referring now to FIG. 10, Screen 9.0 offers the feature of “Shop Finder”, which lists merchants in and around the airport. Screen 9.0 divides merchants into different categories/types. These categories may be changed or expanded at any time. Screen 9.1 displays the merchant listing once the category/type has been chosen. It also allows for a loyalty program between merchants for the passengers that is utilized between merchants. Screen 9.2 displays the merchant advertisement, location and offerings in text format.

Screen 10.0 displays transport option choices for the chosen airport. After selecting the mode of transportation such as a bus or a train, the user then proceeds to the next screens 10.1 and 10.2, which display the transportation merchant/company screen accompanied by advertisements and the transportation company's offering.

On Screen 10.2 the PREV (previous) button is changed to a CALL button, by which the user is able to call directly (“Call-Direct”) the merchant who is making the offer. By pressing the call button, a phone call will be placed to the merchant.

Following the transportation option from the main menu Screen 3.3, the next option is Screen 11.0, “Places to Stay”, which offers lodging information. As with transportation, after a merchant has been selected for a place to stay, the user can choose to utilize the “Call Direct” feature of the method and system in accordance with the present invention.

Referring to FIG. 11, Screens 12.0 (and the accompanying Screens 12.1, 12.2 and 12.3) and 13.0 (and the accompanying Screen 13.1) provide information on local events and attractions that might be of interest to the user, the nature of the event and directions on how to get to the event of interest.

The last 4 options from the Main Menu will give the user the opportunity to return to previous choices with the exception of “Your Feedback” option, shown in Screen 14.0, in which the user's opinion is asked as to how the method and system could be improved. Screen 14.1 displays a final “Thank You” screen, which may include additional information such as a “Tip of the Day”.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An airport information distribution system comprising:
at least one airport data center, the at least one airport data center including a an airport information database and a server coupled to the airport information database;
a network coupled to the at least one data center; and
an information distribution system coupled to the network; the information distribution system including a server system coupled to the network for receiving information from the at least one airport data center and for providing and receiving data from a communication device concerning airport information.

2. The system of claim 1 wherein the network comprises a public network.

3. The system of claim 2 wherein the at least one airport data center includes a first firewall.

4. The system of claim 1 wherein the server system includes;
a server coupled to the network;
a local area network (LAN) coupled to the server; and
a web server coupled to the LAN for receiving airport information from and providing airport information to a communication device.

5. The system of claim 1 wherein the airport information database and the database are coupled via a local area network.

6. The system of claim 4 wherein a first firewall is coupled between the server and the public network and a second firewall is coupled between the web server and the communication device.

7. The system of claim 1 wherein the communication device is wireless.

8. The system of claim 7 wherein the communication device can be any of a personal digital assistant (PDA), mobile telephone, personal computer, and laptop device.

9. The system of claim 1 wherein the airport information database comprises at least one of a flight information database (FID) and a baggage information database (BID).

10. The system of claim 1 wherein a local area network is coupled between the flight information database and the server of the at least one airport data center.

11. The system of claim 1 wherein the server system includes;
a second server coupled to the network;
a local area network (LAN) coupled to the second server; and
a web server coupled to the LAN for receiving airport information from and providing airport information to a communication device.

12. The system of claim 11 wherein the airport information database and the database are coupled via a local area network.

13. The system of claim 12 wherein the network comprises a public network.

14. The system of claim 13 wherein the at least one airport data center includes a first firewall.

15. The system of claim 14 wherein a second firewall is coupled between the second server and the public network and a second firewall is coupled between the web server and the communication device.

16. The system of claim 15 wherein the communication device is wireless.

17. The system of claim 16 wherein the communication device can be any of a personal digital assistant (PDA), mobile telephone, personal computer, and laptop device.

18. The system of claim 17 wherein the airport information database comprises at least one of a flight information database (FID) and a baggage information database (BID).

19. The system of claim 18 wherein a local area network is coupled between the flight information database and the server of the at least one airport data center.

20. The system of claim 1 wherein the information is in multiple languages.

21. The system of claim 19 wherein the information is in multiple languages.

22. A method for distributing airport information comprising the steps:
(a) providing an airport information database within an airport data center;
(b) initiating a request for information from the airport information database by a wireless communication device; and
(c) obtaining information related to the request by the wireless communication device.

23. The method of claim 22 wherein the information comprises local resource information which is specific to a particular airport.

24. The method of claim 23 wherein the local resource information can be any combination of data on flights, baggage location, airport butler, shop finder, transportation system, lodging, directions, local events, local attractions, promotions, feedback, choice of airport and language.

25. The method of claim 24 wherein a passenger is notified/alerted by the wireless device when a plane is boarding passengers

26. A method for distributing airport information comprising the steps: pg,17
(a) providing an airport information database within an airport data center;
(b) initiating a request for local resource information from the airport information database by a wireless communication device; and
(c) obtaining information related to the request by the wireless communication device, wherein passengers are notified whether a flight is cancelled or delayed, wherein the notification is provided via a short message system.

27. A method for distributing airport information comprising the steps:
(a) providing an airport information database within an airport data center;
(b) initiating a request for local resource information from the airport information database by a wireless communication device; and
(c) obtaining information related to the request by the wireless communication device, wherein a passenger can obtain information about different merchants intermingled with advertising, wherein a loyalty program for the passenger is utilized between merchants.

28. A method for distributing airport information comprising the steps:
(a) providing an airport information database within an airport data center;
(b) initiating a request for local resource information from the airport information database by a wireless communication device; and
(c) obtaining information related to the request by the wireless communication device, wherein local transportation information is obtained by the passenger, wherein the modes of transportation are provided, as well as associated advertising.
